(19) United States
(12) Patent Application Publication
(10) Pub. No.: US 2011/0186141 A1
(43) Pub. Date: Aug. 4, 2011

(54) DEVICE AND METHOD FOR POSITIONING TWO BAFFLES ASSOCIATED WITH WIPING OF A GALVANIZING PRODUCT

(75) Inventors: Pierre Bourgier, Sorbiers (FR); Jean-Jacques Hardy, Irigny (FR)

(73) Assignee: SIEMENS VAI METALS TECHNOLOGIES SAS, Saint-Chamond (FR)

(21) Appl. No.: 12/992,724

(22) PCT Filed: May 15, 2008
(86) PCT No.: PCT/FR08/00671

§ 371 Date: Nov. 30, 2010

(51) Int. Cl. B23P 19/00; B05C 3/12; B05C 11/00

(52) U.S. Cl. 137/15.01; 118/419; 118/708

(57) ABSTRACT

A device and a method for positioning two baffles in the vicinity of each of two edges of a moving steel strip exiting a continuous line for dip-galvanizing a strip in a liquid galvanizing product such as liquid zinc. The baffles control turbulence to the side of the two strip edges. Each of the wipers is supported by a beam that is also longer than the strip width. The baffles are arranged on an arm having a width greater than the strip width, the arm having two movable ends, wherein each movable end adjacent to a strip edge is coupled, via two synchronization devices, to each of the respective adjacent ends of the two beams so that the movable end is instantly centered between the two adjacent ends.

The present invention relates to a device and a method for positioning two baffles associated with air wiping of a galvanizing agent as claimed in the preambles to claims 1 and 10.

The invention relates to the positioning of lateral deflectors or baffles used in an air jet wiping system for liquid zinc on a continuous steel strip as it leaves a plating bath of a continuous galvanizing line. Each of the baffles must be disposed at each edge of the strip.

To improve corrosion resistance in certain applications such as the construction and automotive industries or domestic appliances, the surface of the steel strips is coated with a galvanizing agent (liquid then solid) such as zinc or a zinc-based alloy. This coating is applied on continuous galvanizing lines (along which the strip is conveyed) typically comprising:
An input section with one or two strip uncoilers, a guillotine shear, a butt welding machine for joining the tail end of a strip originating from one of the uncoilers to the head of the next strip originating from the other uncoiler, thereby ensuring continuous operation of the line, a strip accumulator which returns to the line strip previously accumulated when uncoiling is stopped upstream of the accumulator to carry out butt welding;
A cold-rolled strip degreasing or hot-rolled strip pickling section;
An annealing furnace which also ensures that the strip is kept at a controlled temperature before it enters a molten zinc bath;
A galvanizing section comprising the zinc bath in which the strip is dipped, then a device for air jet wiping of the liquid zinc, finally an induction alloying furnace, a cooling area and a quenching tank;
An output section with a skin pass rolling mill, a passivation section, an output accumulator, a shear unit and one or two strip recoilers.

On leaving the furnace, the strip is dipped obliquely into an alloying bath of liquid zinc (as a liquid galvanizing agent), deflected vertically by a bottom roll submerged in the bath, next passes over a so-called anti-crossbow roll designed to correct edge camber of the strip resulting from its passage over the bottom roll, then passes over a so-called pass, line roll for adjusting its vertical path as it leaves the bath. When it leaves the plating bath, the strip is covered, on both faces, with a coating of liquid zinc of more or less constant thickness. It is necessary to adjust transversely and longitudinally the thickness of the zinc deposited to a value a near as possible to the desired objective which combines performance in terms of anti-corrosion protection with optimization of the amount of zinc used. For this purpose devices for air wiping the liquid zinc are disposed on either side of the strip surface in order to ensure that the liquid zinc is wiped on both faces of the strip.

Such air wiping systems have been extensively described, for example, in JP 08-2260122 which emphasizes the need to center the strip perfectly between two wipers either side of the strip. Indeed, the wiping effect is very sensitive to the blown air pressure and the distance between blower jets and strip. In order to ensure correct centering, each of the two wipers is equipped at each end with an independent control system, the motors of which are controlled by zinc thickness measuring devices located downstream in the direction of travel of the strip.

In this connection, WO 03/018859 describes a wiper positioning control system with four motors controlled separately as a function of the measured zinc thickness. It also takes account of the effect on centering of the natural curvature of the strip commonly known as the crossbow effect.

However, the side edges of the strip pose specific zinc thickness control problems. In fact, the wipers are at least as long as the maximum width of the strips to be coated. Consequently, as a general rule, there are two zones either side of the width of the strip where the facing wipers blow air directly onto one another. This situation creates on the one hand severe turbulence causing splashes, locally excessive thicknesses, etc, which adversely affect the quality of coating of the edges of the strip. On the other hand, it is accompanied by extremely loud and therefore very troublesome aeraulic noise. Devices located on each side of the strip to provide a continuous obstacle to the wiper jets have therefore long been proposed. One of these devices is disclosed in JP 02-107752 which describes a wiping system comprising two wipers and two baffles inserted between the wipers parallel to each lateral edge of the strip. A movement actuator acting in the plane of the strip keeps each of the baffles at a slight distance from the edges of the strip, in the order of a millimeter. This distance is maintained either by measuring the position of the edge of the strip and controlling the movement actuators accordingly, or using rollers coming into contact with the strip edges. Other approaches attempt to provide improvements to this basic device, such as JP 06-330275 which describes baffles positioned in the vertical plane of the strip at a slight distance from and on each side of the latter using systems for measuring the position and any edge camber of the strip. These systems control, on each side of the strip, two movement actuators acting in one case on the plane of the strip and, in the other case, perpendicular to that plane. Although such a device seems capable of solving the baffle positioning problem, it appears to be quite complex, with multiple movement actuators and multiple measuring systems which, even if not described, are inevitable according to the knowledge of a person skilled in the art.

Some years later, EP 1 077 269 describes such a system, but having movement actuators only in the plane of the strip in order to adapt to width variations in the latter, effectively reverting to the single direction positioning control described by JP 02-107752. Another document JP 2002-30407 also essentially adopts the approach described in JP 02-107752.

The currently operational air wiping devices of the continuous steel strip dip-galvanizing installations all comprise baffles whose position in the strip plane is controlled by systems operating with or without contact with the strip in order to adapt automatically to the width variations in the latter. The baffles and their lateral positioning means are generally supported by a beam spanning the entire width of the coating installation, as illustrated by JP 2002-30407, for example. Said beam has its own supports disposed on either side of a crucible containing the bath of liquid zinc or, in some cases, is mounted to the supports of one of the wipers.

As already indicated, air wiping is very sensitive to the distance between the blower jets and the strip and, during operation, the position of the wipers is continuously adjusted dynamically by the coating thickness control system such that the mean plane of the strip always remains equidistant from the two wipers. By “mean plane” is meant a vertical plane passing through the cross-section of the strip and for which the thickness control system achieves an optimum coating thickness distribution on both faces of the strip. In, the course of a plating campaign, i.e. during the several weeks of continuous production between two shutdowns to change the submerged rolls, the position of the mean plane may vary by more than 10 millimeters. This variation is essentially due to submerged roll bearing wear and also to changes in the strip format. Strip format is to be understood as meaning not only the strip's thickness and width but also its mechanical characteristics. Any position variation in the mean plane in the order of a millimeter means poor positioning of the baffles relative to the edges of the strip and requires position adjustment of the latter.

In addition to this position variation in the mean plane of the strip, at each change of strip format there is a variation in the amplitude of the crossbow in the form of a variation in position of its edges relative to the mean plane. This positioning deviation between the mean plane of the strip and the plane containing the center of its edges is often termed the offset. The offset variations which can attain several millimeters generally only occur at strip format changes.

Generally speaking, the position of the baffles relative to the strip edges is controlled manually by operators at the start of each plating campaign. It is then adapted during the plating campaigns to each change in strip format (thickness, width, mechanical characteristics), to each adjustment of the pass line and anti-crossbow rolls, and to variations in the tension of the strip as it leaves the plating bath. In the case where the beam supporting the baffles is mounted on supports of one of the wipers, it even becomes necessary to reset the wiper position adjustments. To provide manual control of the baffles, very frequent operator intervention is therefore clearly necessary in what is a very hostile environment due to the immediate proximity of the molten zinc bath at more than 450° C., the intense aeraulic noise generated by air jet wiping, and the risks of strip breakage, etc.

An object of the present invention is therefore to allow automatic positioning of the baffles, i.e. in particular considerably reducing human intervention.

This object is achieved by a positioning device and method as claimed in claims 1 and 10.

On the basis of a device for positioning two baffles in the vicinity of each of the two edges of a steel strip exiting a continuous line for dip-galvanizing a strip in a liquid galvanizing agent such as liquid zinc, said baffles being designed to limit turbulence to the side of the two strip edges, said turbulence resulting from at least two flows for air wiping of the liquid agent on each surface of the strip, said flows being wider than the strip width and coming from two air jet wipers located either side of the surface of the strip, each of the wipers being supported by a beam (likewise longer than the strip width), it is provided according to the invention that the baffles are disposed on an arm that is wider than the strip width, said arm having two movable ends, wherein each movable end adjacent to an edge of the strip is coupled by means of two synchronization devices to each of the respective adjacent ends of the two beams so that the movable end is instantaneously centered between the two adjacent ends. As the baffles are thus positioned by simple mechanical and automatic actuation from the wiper beams, it is advantageously possible to reduce the need for human intervention in order to adjust the baffles.

Such units for air wiping liquid zinc on a steel strip in continuous dip-galvanizing lines have an automatic control system which also dynamically adjusts the position of wiper supports either side of the strip, and is characterized by the fact that the arm or another baffle support is also actuated so that the baffles are automatically aligned to the target equidistance plane of the wipers defining the mean plane of the strip, and this irrespective of the position and displacements of the wipers.

Similarly proposed is a baffle positioning method specifically designed for implementing the device presented above.

On the basis of a method for positioning two baffles in the vicinity of each of the two edges of a steel strip exiting a continuous line for dip-galvanizing strips in a liquid galvanizing agent, said baffles being designed to limit turbulence to the side of the two strip edges, said turbulence resulting from at least two flows for air wiping the liquid agent on each surface of the strip, said flows being wider than the strip width and coming from two air jet wipers located either side of the surface of the strip, each of the wipers being supported by a beam (likewise longer than the strip width), it is provided according to the invention that the baffles are disposed on an arm that is wider than the strip width, said arm being actuated by its two movable ends wherein each movable end adjacent to an, edge of the strip is subject to synchronous mechanical movement transmission from each of the adjacent ends of the two beams ensuring an average movement of the arm (or of its ends directly actuated mechanically by the ends of the beams) of a value equal to half the algebraic sum of relative displacements of the beams.

A set of sub-claims also sets out advantages of the invention, the contents of which will also be supported in the continuation of the description.

Exemplary embodiments and applications will be described with reference to the accompanying drawings:

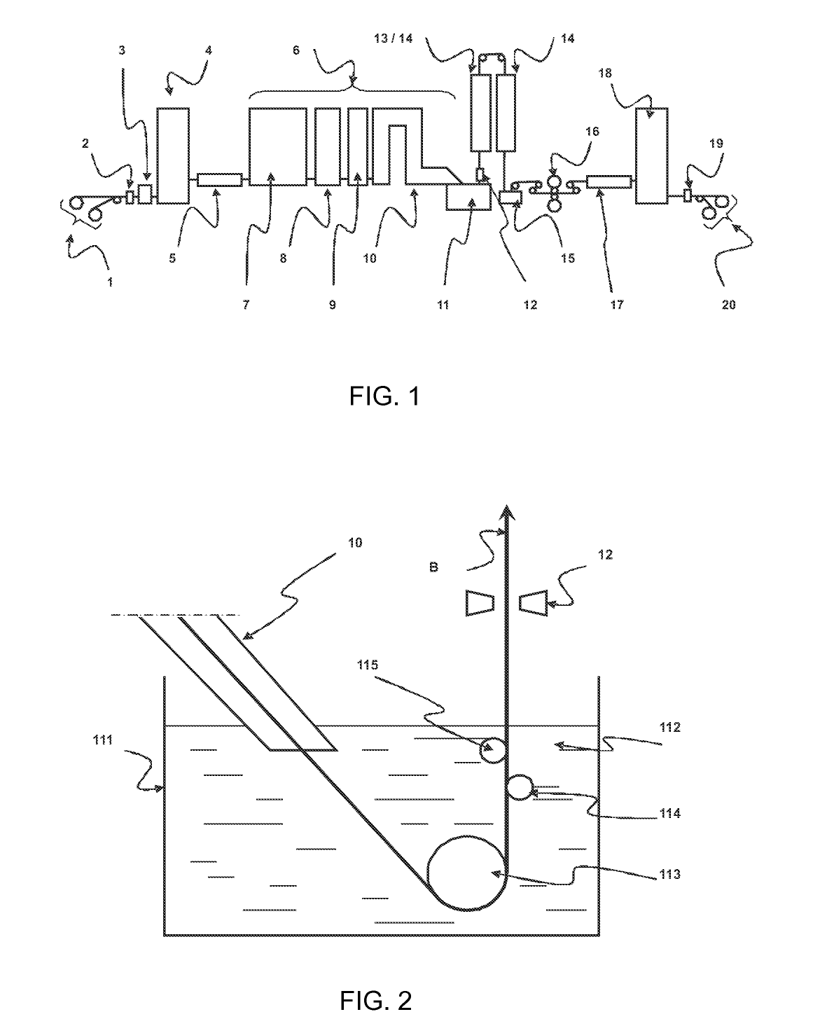

FIG. 1 Arrangement of a continuous steel strip dip-galvanizing line,

FIG. 2 Arrangement of the zinc bath zone,

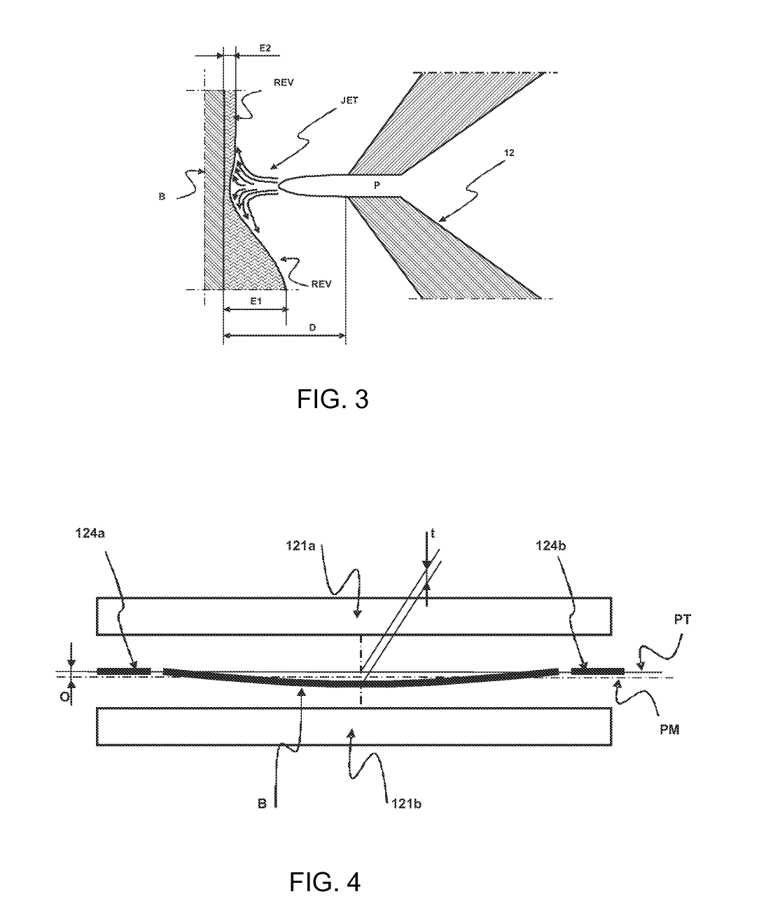

FIG. 3 Forced air wiping principle,

FIG. 4 Principle of positioning baffles relative to the edges of the strip,

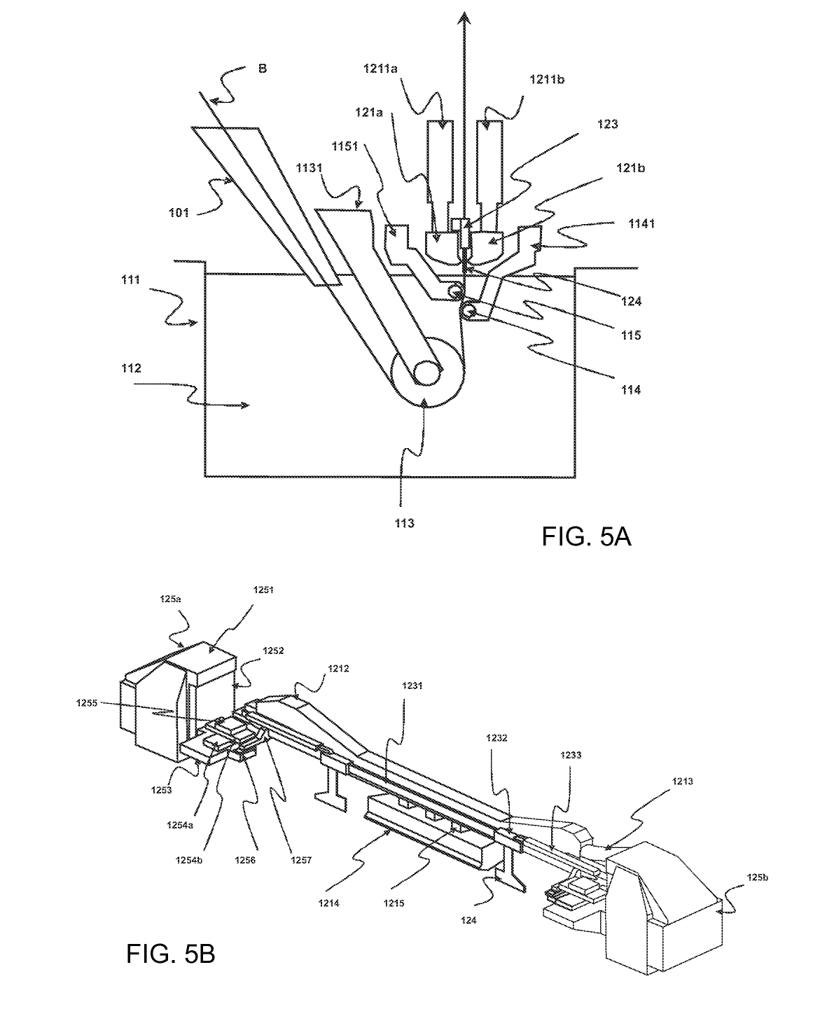

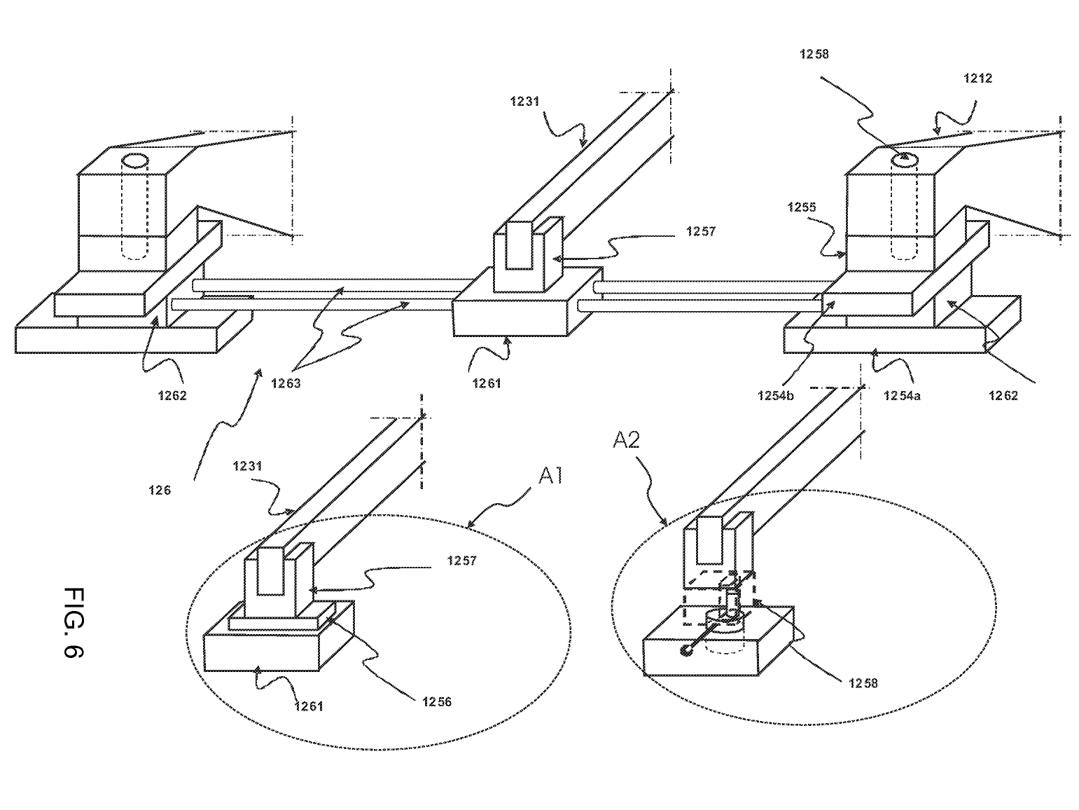

FIG. 5a, 5b Arrangement of a wiping device,

FIG. 6 First embodiment of a positioning device according to the invention,

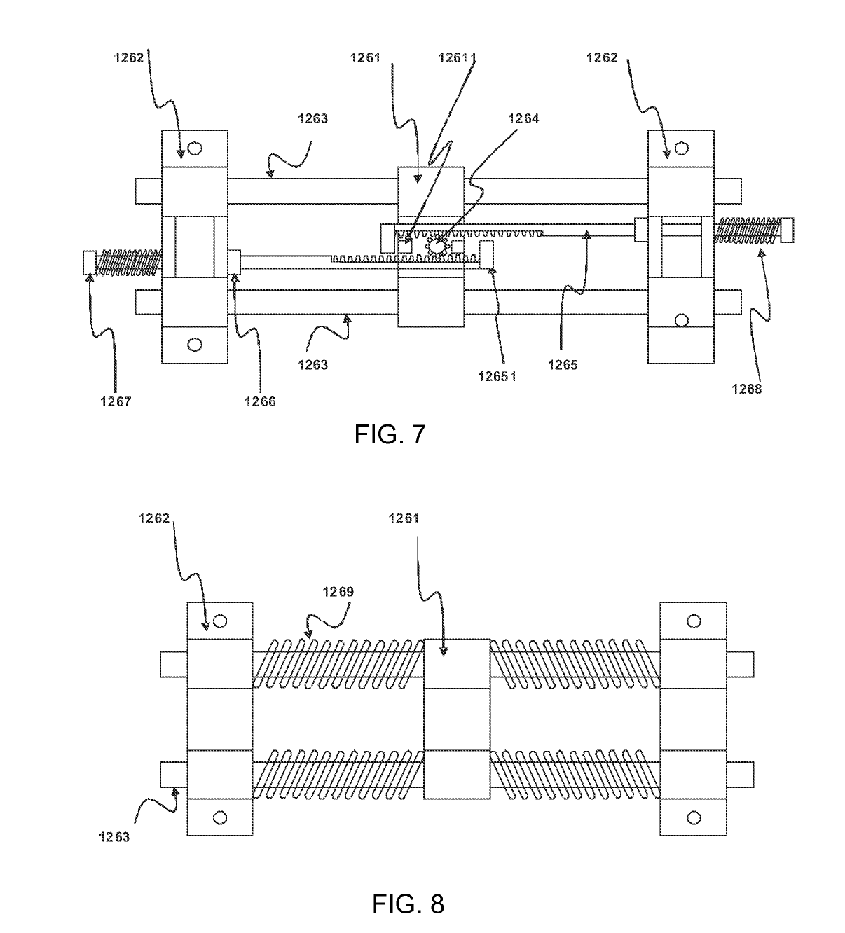

FIG. 7 Second embodiment of a positioning device according to the invention,

FIG. 8 Third embodiment of a positioning device according to the invention,

FIG. 1 shows a typical arrangement of a continuous steel stripdip-galvanizing line comprising, in the sequential conveying direction of the strip along the line:
An input section with one or two strip uncoilers (1), a guillotine shear (2), a butt welding machine (3) for joining a tail end of a strip originating from one of the uncoilers to the head of the next strip originating from the other uncoiler, thereby ensuring continuous operation of the line, strip accumulator which returns to the line strip previously accumulated when uncoiling is stopped upstream of the accumulator to carry out butt welding;
A cold-rolled strip degreasing or hot-rolled strip pickling section (5);
An annealing furnace (6) comprising a heating section (7), a holding section (8), a cooling section (9) and a section (10) (such as a furnace) for keeping the strip at a controlled temperature before it enters a molten zinc bath;
A galvanizing section as such with the zinc bath (11) in which the strip is dipped, a liquid zinc air wiping device (12), and finally an induction alloying furnace (13), a cooler (14) and a quenching tank (15);
An output section with a skin pass rolling mill (16), a passivation section (17), an output accumulator (18), a shear unit (19) and one or two strip recoilers (20).

FIG. 2 shows an arrangement of the zinc bath zone according to FIG. 1. The steel strip (B) leaves a furnace (10) by a sleeve (101) descending obliquely into a liquid bath (112) comprising a liquid galvanizing agent and contained in a plating tank (111) designed for depositing the galvanizing agent on each side of the strip. The strip is deflected vertically by a submerged roll (113) known as the “bottom roll”, then comes into contact with a so-called anti-crossbow roll (114) for correcting the edge camber of the strip resulting from its passage over the bottom roll, then over a so-called pass line roll (115) for adjusting its vertical path as it leaves the bath. Thus the strip then leaves the plating bath vertically before entering an air wiping device (12).

FIG. 3 shows the principle of forced air wiping on one of the sides of the strip (B), said principle being applicable within the scope of the invention. A jet of air (JET) from the wiping device (12) according to FIG. 2 subjects the liquid galvanizing coating (REV) of the strip (B) to a constriction effect which causes its thickness prior to solidification to go from a value (E₁) on entry under the jet to another value (E₂) on exit. A distance (D) between the vertically moving strip and an air outlet section of the wipers as well as the air pressure (P) are critical variables which influence the wiping operation and therefore the desired properties of the galvanizing coating.

FIG. 4 describes a principle of positioning baffles in relation to the strip edges, here in a top view with respect to the direction of travel of the strip. The strip (B) moving between two wipers (121a) and (121b) located either side is affected by transverse bend (t) also known as “crossbow”. A mean plane (PM) of the strip is defined as a vertical plane passing through a cross-section of the strip and for which a thickness control system achieves an optimum distribution of the thickness of the wanted coating on both faces of the strip. A distance (O) between this mean plane (PM) and a second plane (PT) Passing through the longitudinal axis of the two edges of the strip is therefore defined. The two baffles (124a) and (124b) must then be aligned in the second plane (PT) and are therefore at a distance from the mean plane (PM), said distance being called the “offset” (O).

FIGS. 5a and 5b describe a wiping device arrangement, FIG. 5a showing the wiping device in relation to the plating bath as per FIG. 2 (side view), while FIG. 5b is a perspective view of the wiping device per se.

FIG. 5a shows the steel strip (B) leaving a sleeve (101) and descending obliquely into the liquid bath (112) contained in the plating tank (111). The strip is then deflected vertically by the submerged bottom roll (113) and supported by two arms (1131), then comes into contact with the anti-crossbow roll (114), itself supported by two arms (1141) integral with or independent of (1131), then via the pass line roll (115) supported by two arms (1151). The strip then leaves the plating bath vertically to pass between two wipers (121a) and (121b) supplied by compressed air (1211a) and (1211b) over at least the entire strip width. A retaining arm (123) parallel to the wipers and located between them supports the baffles (124).

FIG. 5b shows a perspective view of a complete wiping unit. For reasons of clarity, a single wiper has been illustrated. This unit comprises two carrying systems (125a) and (125b) located to the side of the strip edges and each comprising a support (1251) to which is fixed a vertical displacement table (1252) supporting a bracket in the form of a plate (1253). This plate (1253) is equipped with two sets of horizontal displacement tables each comprising a displacement table (1254a) acting in a direction perpendicular to the plane of the strip and a second table (1254b) acting perpendicularly to the first. A support (1255) integral with the plate (1253) receives one end of one of the beams supporting a wiper (1212), the other opposite end of the same beam being supported in the same manner. This beam (1212) receives the compressed air via a main duct (1213) and injects it into a diffuser box (1214) via distribution ducts (1215). The plate (1253) also comprises a horizontal displacement table (1256) acting in a direction perpendicular to the plane of the strip and holds a support (1257) of the retaining unit of the baffles (123). This retaining unit comprises at least one arm (1231) on which two carriages (1232) move, actuated by a displacement device (1233), e.g. a jack. Each carriage (1232) carries a baffle (124).

FIG. 6 shows a first embodiment of a device according to the invention. For reasons of clarity, the arm (1231) in its entirety, the baffles (123) and the wipers (1214) according to FIG. 5 are not shown. Only the ends (1261) of the arm (1231) and the adjacent ends (1262) of the two beams (1212) in proximity to one of the two strip edges and supporting the wipers on either side of the sides of the strip are illustrated.

What is described is essentially a device for positioning two baffles in the vicinity of each of the two edges of a steel strip exiting a continuous line for dip-galvanizing strips in a liquid galvanizing agent, said baffles being designed to limit turbulence to the side of the two strip edges, said turbulence resulting from at least two flows for air wiping of the liquid agent on each surface of the strip, said flows being wider than the strip width and coming from two air jet wipers located either side of the surface of the strip, each of the wipers being supported by a beam (1212) (likewise longer than the strip width).

The baffles are disposed on an arm (1231) that is wider than the strip width, said arm (1231) having two movable ends (1261, 1257), wherein each movable end adjacent to an edge of the strip is coupled by means of two synchronization devices to each of the respective adjacent ends (1262) of the two beams (1212) so that the movable end is instantaneously centered between the two adjacent ends.

Each synchronization device comprises at least two elements (1263) extending transversely and laterally with respect to the strip, each respectively connecting, over a variable transverse length, the end of the arm to one of the adjacent ends of the two beams. In particular, the elements (1263) are at least sliding, telescopic or articulated such that in the event of a dynamic displacement of the adjacent end of the beams, a synchronous displacement shall be induced by simple mechanical actuation of the movable end of the arm so as to center the latter between the two others. For this purpose, in the upper part of FIG. 6, the elements (1263) are rods (1263) synchronously sliding through a plate (1261) supporting the movable end of the arm (1231) or through a support (1255, 1262) of the adjacent end of one of the beams (1212).

In the two enlarged views A1, A2 in the lower part of FIG. 6, the end of the arm is illustrated in greater detail, showing that the plate (1251) is coupled to the arm (at its end) by an eccentering position adjusting means (1255, 1258) designed to compensate for centering “offset” as described above.

It is thus possible to provide two supports at the ends of the arm supporting the baffles with manual or motorized devices for adjusting the position of the baffles by the offset value. In the case where these adjustment devices are motorized, they can be controlled by a strip edge position detecting system, e.g. noncontacting position sensors or image capture devices. Moreover, the constant and automatic centering of the baffle arm support device assembly in relation to the two movable wipers hand eliminates the possibility of interference between the three ends (that of the two beams and that of the arm) which could make it impossible for the coating thickness control system to correct the position of the wipers. This situation may arise, for example, when the position of the baffles has not been rectified or has been inadequately rectified after a displacement of the mean plane of the strip.

In detail and according to FIG. 5b, FIG. 6 thus shows a device (126) comprising two plates (1262) (one for each beam) integral with the movable part of the displacement tables (1254a) acting in a direction perpendicular to the plane of the strip. These plates (1262) can, for example, be disposed between the displacement tables (1254a) and (1254b). A synchronisation device (1263) ensures that a third plate (1261) is always located in a position equidistant from the two plates (1262) irrespective of the displacements of the movable part of each of the displacement tables (1254a). Each plate (1261) carries a support (1257) for the baffle supporting are (1231).

As shown in the enlarged view A1, a displacement table (1256) is fixed to the plate (1261), directly supports the end of the arm (1231), acts in a direction perpendicular to the plane of the strip and therefore advantageously provides offset adjustment. The displacement table (1256) can be adjusted manually or by motor.

Alternatively, according to the enlarged view A2, an eccentric manual adjustment device (1258) inserted between the plate (1261) and the end of the arm (1231) can also provide the offset adjustment function. Such devices are well known in the prior art and will not be explained in greater detail in this description.

FIG. 7 shows a second embodiment of a device according to the invention, in particular with reference to FIG. 6.

The baffle positioning device thus comprises the following characteristics:
the rods (1263) slide in each beam support (1255, 1262),
the plate (1261) comprises a synchronization pinion (1264) which meshes with two racks (1265), each disposed parallel to each rod (1263),
each rack (1265) is coupled to one of the beam supports (1255, 1262) by means of a stop ring (12) and a calibrated spring (1268).

In more detail, two plates (1262) integral with the movable part of the displacement tables (1254a, 1254b) (not shown, see FIGS. 5b and 6) inserted between each beam (1212) and each associated support (125a, 125b) have two guide elements in which the two rods (1263) can slide freely, in the form of columns. These columns provide mechanical guidance of the plate (1261) via two guide elements in which they can slide freely. As mentioned above, the plate (1261) comprises the synchronization pinion (1264) which meshes with the two racks (1265). Each rack associated with one of the plates (1262) has two stop rings (1266) and (1267) and a spring (1268). Each of the springs is calibrated to provide, in both directions, the drive to the rack (1265) and by extension the desired continuous centering of the plate (1261) linked to the arm supporting the baffles. When, in the event of backward movement of the plates (1262), stops (12651) at the ends of each rack come into contact with stop blocks (12611) disposed on the internal sides of the plate (1261) linked to the arm, the springs are compressed, thereby providing the plates (1262) linked to the beams, and therefore the wipers, with a much greater range of movement than that necessary for position adjustment during wiping but which is indispensable during maintenance work.

FIG. 8 shows a third embodiment of the device according to the invention, in particular with reference to FIG. 6.

The baffle positioning device thus has the following characteristics:
the rods (1263) slide in each beam support (1255, 1262),
calibrated springs (1269) are disposed concentrically to the rods (1263) between the plate (1261) and each beam support (1255, 1262).

In more detail, the two plates (1262) integral with the movable part of the displacement tables (1254a, 1254b) (not shown, see FIGS. 5b and 6) inserted between each beam (1212) and each associated support (125a, 125b) have two guide elements in, which the two rods (1263) can slide freely, in the form of columns. These columns provide mechanical guidance of the plate (1261) via two guide elements in which they can slide freely. Four identically calibrated springs (1269) are disposed concentrically to the columns (1263) between each of the plates (1262) on the one hand and the plate (1261) on the other. The identical calibration of the springs ensures that the plate (1261) and therefore each end of the arm carrying the baffles is always in a median position between the plates (1262) which equate to the adjacent ends of the beams holding the wipers.

For all the embodiments described above, centering offset adjustment arrangements (with an eccentering means) can be implemented in the manner of FIG. 6.

In addition, it is also specified that the supports (1255, 1262) of each beam (at their ends) are disposed on independent displacement tables (1254a, 1254b), such as motorized positioners designed for bidirectional movement that is freely and dynamically definable according to the wiping conditions. The arm actuated mechanically by the beams as they move therefore also undergoes dynamically induced displacements while remaining correctly positioned in the mean plane of the strip. To allow this, the supports and the displacement tables are controlled by at least one system for detecting the strip position in relation to the wipers or a system for measuring a thickness of the liquid galvanizing agent on the strip surface.

1-10. (canceled)

11. In a continuous dip-galvanizing system for dip-galvanizing a steel strip with liquid galvanizing agent, a device for positioning two baffles in a vicinity of each of two edges of the steel strip exiting a continuous line for dip-galvanizing, the baffles being configured to limit turbulence laterally of the two strip edges, the turbulence resulting from at least two flows for air wiping of the liquid galvanizing agent on each surface of the strip, the flows being wider than a strip width and coming from two air jet wipers located on either side of a surface of the strip, and each of the wipers being supported by a beam, the device comprising:
an arm supporting the baffles, said arm having a width greater than a width of the strip, and having two movable ends;
two synchronization devices disposed to couple each of said movable ends adjacent to an edge of the strip to each of a respectively adjacent end of the two beams, so that said movable end is instantaneously centered between the two adjacent ends.

12. The device according to claim 11, wherein each one of said synchronization devices comprises at least two elements that extend transversely and laterally with respect to the strip, each of said synchronization devices respectively connecting an end of the arm to one of the adjacent ends of the two beams over a variable transverse length.

13. The device according to claim 12, wherein said at least two elements are selected from the group consisting of sliding elements, telescopic element, and articulated elements.

14. The device according to claim 12, wherein said elements are rods sliding synchronously through a plate supporting said movable end of said arm or through a support of an adjacent end of one of the beams.

15. The device according to claim 14, which comprises a device for adjusting an eccentric position and to compensate for a centering offset, said device coupling said plate to said arm.

16. The device according to claim 14, wherein:
said rods are slidably disposed in each beam support;
said plate has a synchronization pinion disposed to mesh with two racks, each disposed parallel to each rod;
each of said two racks is coupled to one of the beam supports by way of a stop ring and a calibrated spring.

17. The device according to claim 14, wherein:
said rods are slidably disposed in each beam support;
calibrated springs are disposed concentrically to said rods between said plate and each beam support.

18. The device according to claim 11, wherein the beam is supported on beam supports and said beam supports are disposed on displacement tables.

19. The device according to claim 18, wherein said beam supports are supported on motorized positioners configured for bidirectional displacement.

20. The device according to claim 18, wherein said beam supports and said displacement tables are controlled by at least one system for detecting a strip position in relation to the wipers or a system for measuring a thickness of a liquid galvanizing agent on the strip surface.

21. A method for positioning two baffles in a vicinity of each of the two edges of a steel strip exiting a continuous line for dip-galvanizing strips in a liquid galvanizing agent, the baffles being configure to limit turbulence to a side of the two strip edges, the turbulence resulting from at least two flows for air wiping the liquid agent on each surface of the strip, the flows being wider than a strip width and originating from two air jet wipers located on either side of a surface of the strip, and each of the air jet wipers being supported by a beam, the method which comprises:
providing an arm having the baffles disposed thereon, the arm having a width greater than a width of the strip;
actuating the arm by two movable ends thereof, thereby subjecting each of the movable ends adjacent to an edge of the strip to synchronous mechanical movement transmission from each of the adjacent ends of the two beams, and ensuring an average displacement of the arm by a value equal to one half an algebraic sum of relative displacements of the beams.
